(19) United States
(12) Patent Application Publication
(10) Pub. No.: US 2016/0096399 A1
(43) Pub. Date: Apr. 7, 2016

(54) Store Downloader

(71) Applicant: Michael Lewis Moravitz, Fairfax, VA (US)

(72) Inventor: Michael Lewis Moravitz, Fairfax, VA (US)

(21) Appl. No.: 14/120,022

(22) Filed: Sep. 30, 2014

(51) Int. Cl. B60C 7/00

(52) U.S. Cl. CPC B60C 7/00

(57) ABSTRACT

Terminals at stores connected to internet sites to download digitized sound and video to MP3 players for customers.

Perhaps businesses, libraries, and schools could provide downloadable music, video, audio and ebooks, and other digitized material at central download pods with access to the internet and a site with the material. Currently, some MP3 players, like the Ipod, are sold with preloaded music or other digitized material. However, this is not very practical since you can't change your material over time or select what you want exactly. Consumers can also download digitized material from internet sites, but not everyone has access to computers or the internet at their homes, workplaces, or schools. Consumers might more readily change what is on their mp3 player to reflect current hits or what they want to buy with a store downloader.

Businesses could provide music, video, and other digitized material on central download pods (essentially computer terminals with internet access to music and video providers) that the consumer could plug in, pay a fee, and download from a site. Stores might set up their own choices of music and/or video rather than current sites such as Itunes. This would require an entrepreneur willing to add download pods to existing entertainment or home technology stores, or create a new business model. Even drug or grocery stores might provide downloadable music and/or video internet access. Book stores might also provide audio or ebook download sites. All sorts of businesses could provide downloaders at select locations for fees, or through libraries, schools, and universities. While the internet might remain the main source of these materials, the downloaders might be easy to set up and might make a sizeable profit with simple maintenance. Teachers could also provide material to students this way.

1. Builds on claims for such music download sites as Amazon.com and ITunes. Terminals in stores would build on claims for computers linked to Internet in which music and video could be selected, bought, and downloaded by the customer.
